(19) United States
(12) Patent Application Publication
(10) Pub. No.: US 2026/0081992 A1
(43) Pub. Date: Mar. 19, 2026

(54) UTILIZING LOCATION INFORMATION TO MAKE CALL ROUTING DECISIONS

(71) Applicant: T-MOBILE INNOVATIONS LLC, Overland Park, KS (US)

(72) Inventors: A. Karl Corona, Maple Valley, WA (US); Harikishore Allu Balan, Lynnwood, WA (US)

(21) Appl. No.: 18/888,548

(22) Filed: Sep. 18, 2024

(51) Int. Cl. H04M 3/42

(52) U.S. Cl. CPC H04M 3/42357; H04M 2242/30

(57) ABSTRACT

Systems and method are contemplated herein for method for making or facilitating a call routing decision associated with a call (e.g., a voice call, a video call). A TAS may receive the invite message and request location information associated with a mobile-terminating UE (MT-UE) from a subscriber network function (NF). The TAS may receive the location information from the subscriber NF. Based on the location information, the TAS may determine the call routing decision. The call routing decision may include one of routing the invite message to a first domain, routing the invite message to a second domain, redirecting the invite message, or rejecting the invite message.

### SUMMARY

The present disclosure is directed, in part to utilizing location information to make call routing decisions, substantially as shown and/or described in connection with at least one of the figures, and as set forth more completely in the claims.

According to various aspects of the technology, when a particular subscriber attempts to call another subscriber, an invite message associated with the call may take various paths to be delivered to the call-receiving subscriber, such as via a circuit-switched (CS) domain or a packet-switched (PS) domain. Conventionally, the decision of whether to route the invite message through the CS domain or the PS domain is a simple decision based on limited information, such as the preference of a mobile-terminating UE (MT-UE). Typically, a telephone application server (TAS) receives the invite message and requests information associated with the MT-UE. Based on this limited information, the TAS determines whether to route the message to the CS or PS domain. However, in some scenarios, this may result in invite messages taking an unfavorable and unnecessary path due to a lack of complete information. Systems and methods enabling the TAS to make a better informed call routing decision are contemplated.

This summary is provided to introduce a selection of concepts in a simplified form that are further described below in the detailed description. This summary is not intended to identify key features or essential features of the claimed subject matter, nor is it intended to be used in isolation as an aid in determining the scope of the claimed subject matter.

### BRIEF DESCRIPTION OF THE DRAWINGS

FIG. 1 illustrates an exemplary computing device for use with the present disclosure;

FIG. 2 illustrates a diagram of an exemplary network environment in which implementations of the present disclosure may be employed;

FIG. 3 illustrates a flow diagram of an exemplary method for making a call routing decision associated with a call in which implementations of the present disclosure may be employed;

FIG. 4 illustrates a flow diagram of an exemplary method for making a call routing decision associated with a call in which implementations of the present disclosure may be employed; and

FIG. 5 illustrates a flow diagram of an exemplary method for facilitating a call routing decision associated with a call in which implementations of the present disclosure may be employed.

### DETAILED DESCRIPTION

The subject matter of embodiments of the invention is described with specificity herein to meet statutory requirements. However, the description itself is not intended to limit the scope of this patent. Rather, the inventors have contemplated that the claimed subject matter might be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

Various technical terms, acronyms, and shorthand notations are employed to describe, refer to, and/or aid the understanding of certain concepts pertaining to the present disclosure. Unless otherwise noted, said terms should be understood in the manner they would be used by one with ordinary skill in the telecommunication arts. An illustrative resource that defines these terms can be found in Newton's Telecom Dictionary, (e.g., 32d Edition, 2022). As used herein, the term “base station” refers to a centralized component or system of components that is configured to wirelessly communicate (receive and/or transmit signals) with a plurality of stations (i.e., wireless communication devices, also referred to herein as user equipment (UE(s))) in a particular geographic area. As used herein, the term “network access technology (NAT)” is synonymous with wireless communication protocol and is an umbrella term used to refer to the particular technological standard/protocol that governs the communication between a UE and a base station; examples of network access technologies include 3G, 4G, 5G, 6G, 802.11x, and the like.

Embodiments of the technology described herein may be embodied as, among other things, a method, system, or computer-program product. Accordingly, the embodiments may take the form of a hardware embodiment, or an embodiment combining software and hardware. An embodiment takes the form of a computer-program product that includes computer-useable instructions embodied on one or more computer-readable media that may cause one or more computer processing components to perform particular operations or functions.

Computer-readable media include both volatile and nonvolatile media, removable and nonremovable media, and contemplate media readable by a database, a switch, and various other network devices. Network switches, routers, and related components are conventional in nature, as are means of communicating with the same. By way of example, and not limitation, computer-readable media comprise computer-storage media and communications media.

Computer-storage media, or machine-readable media, include media implemented in any method or technology for storing information. Examples of stored information include computer-useable instructions, data structures, program modules, and other data representations. Computer-storage media include, but are not limited to RAM, ROM, EEPROM, flash memory or other memory technology, CD-ROM, digital versatile discs (DVD), holographic media or other optical disc storage, magnetic cassettes, magnetic tape, magnetic disk storage, and other magnetic storage devices. These memory components can store data momentarily, temporarily, or permanently.

Communications media typically store computer-useable instructions – including data structures and program modules – in a modulated data signal. The term “modulated data signal” refers to a propagated signal that has one or more of its characteristics set or changed to encode information in the signal. Communications media include any information-delivery media. By way of example but not limitation, communications media include wired media, such as a wired network or direct-wired connection, and wireless media such as acoustic, infrared, radio, microwave, spread-spectrum, and other wireless media technologies. Combinations of the above are included within the scope of computer-readable media.

By way of background, subscribers communicate globally with subscribers of various networks. When a particular subscriber attempts to call another subscriber, an invite message associated with the call may take various paths to be delivered to the call-receiving subscriber. For example, if the call receiving subscriber is registered with an IP multimedia subsystem (IMS) network, the invite message may be routed through the packet-switched (PS) domain, and if the call-receiving subscriber is not registered with the IMS network, the invite message may be routed through the circuit-switched (CS) domain. However, for example, the CS domain is associated with dated technology, reduced efficiency and scalability, and a lower quality of service. Further, this dated technology is being decommissioned as newer technology takes hold. There are numerous specific examples illustrating a need for improved call routing decision making. A call receiving subscriber may be unregistered with the IMS network for numerous reasons, and many of these reasons do not necessitate routing the invite message to the CS domain. For example, the call receiving subscriber may be unregistered due to a registration failure, but may be otherwise IMS-capable, authenticated, and can receive IMS services. As a result, invite messages destined for unregistered subscribers may take an unfavorable and unnecessary path through the CS domain. Call receiving subscribers may receive a lower quality of service despite being eligible for the higher quality of service associated with the PS domain.

Conventionally, the decision of whether to route the invite message through the CS domain or the PS domain is a simple decision based on limited information. Typically, a telephone application server (TAS) receives the invite message and requests information associated with the call-receiving subscriber. This information is often obtained from a subscriber network function (NF), such as the home subscriber server (HSS). The information may include the preference of the UE associated with the call-receiving subscriber. In instances where the call-receiving subscriber is unregistered with the IMS network and/or requests unregistered services, this information may be limited or unknown. As a result, the invite message is routed through the CS domain to the call-receiving subscriber, resulting in reduced efficiency and quality of the communication.

In contrast to conventional solutions and to facilitate a more optimized use of the 5G core network, the present disclosure is directed to providing additional information to a 5G TAS to make a call routing decision. The TAS is presently unaware of the full picture regarding the call-receiving subscriber. For example, the call-receiving user may be a roaming user whose device is IMS-capable, however, the roaming user is not registered in the network due to their nature as a roamer. The TAS may request and receive location information such as a public land mobile network identifier (PLMN ID), a cell identifier (cell ID), and/or a radio access technology (RAT) type associated with the call-receiving subscriber. Based on this location information, the TAS may consider whether the CS domain fallback is truly necessary. Further, the TAS may consider this location information and determine to perform alternative call handling, such as sending the call to a voicemail server associated with the call-receiving subscriber. This solution provides a more tailored approach to making call routing decisions in a 5G core network.

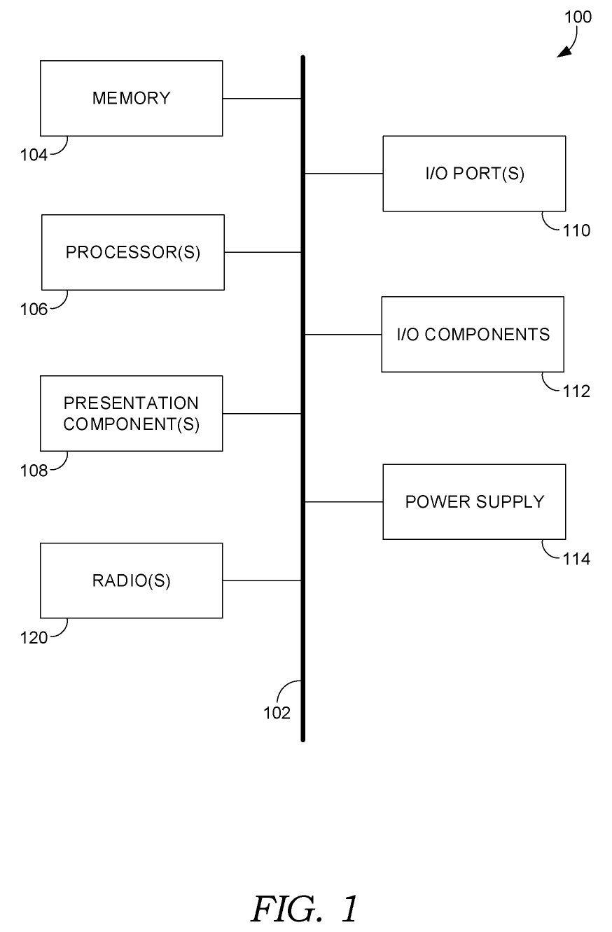

Referring to FIG. 1, an exemplary computer environment is shown and designated generally as computing device 100 that is suitable for use in implementations of the present disclosure. Computing device 100 is but one example of a suitable computing environment and is not intended to suggest any limitation as to the scope of use or functionality of the invention. Neither should computing device 100 be interpreted as having any dependency or requirement relating to any one or combination of components illustrated. In aspects, the computing device 100 is generally defined by its capability to transmit one or more signals to an access point and receive one or more signals from the access point (or some other access point); the computing device 100 may be referred to herein as a user equipment (UE), wireless communication device, or user device. The computing device 100 may take many forms; non-limiting examples of the computing device 100 include a fixed wireless access device, cell phone, tablet, internet of things (IoT) device, smart appliance, automotive or aircraft component, pager, personal electronic device, wearable electronic device, activity tracker, desktop computer, laptop, PC, and the like.

The implementations of the present disclosure may be described in the general context of computer code or machine-useable instructions, including computer-executable instructions such as program components, being executed by a computer or other machine, such as a personal data assistant or other handheld device. Generally, program components, including routines, programs, objects, components, data structures, and the like, refer to code that performs particular tasks or implements particular abstract data types. Implementations of the present disclosure may be practiced in a variety of system configurations, including handheld devices, consumer electronics, general-purpose computers, specialty computing devices, etc. Implementations of the present disclosure may also be practiced in distributed computing environments where tasks are performed by remote-processing devices that are linked through a communications network.

With continued reference to FIG. 1, computing device 100 includes bus 102 that directly or indirectly couples the following devices: memory 104, one or more processors 106, one or more presentation components 108, one or more input/output (I/O) ports 110, one or more I/O components 112, and power supply 114. Bus 102 represents what may be one or more busses (such as an address bus, data bus, or combination thereof). Although the devices of FIG. 1 are shown with lines for the sake of clarity, in reality, delineating various components is not so clear, and metaphorically, the lines would more accurately be grey and fuzzy. For example, one may consider a presentation component such as a display device to be one of the one or more I/O components 112. Also, processors, such as the one or more processors 106, have memory. The present disclosure hereof recognizes that such is the nature of the art, and reiterates that FIG. 1 is merely illustrative of an exemplary computing environment that can be used in connection with one or more implementations of the present disclosure. Distinction is not made between such categories as “workstation,” “server,” “laptop,” “handheld device,” etc., as all are contemplated within the scope of FIG. 1 and refer to “computer” or “computing device.”

Computing device 100 typically includes a variety of computer-readable media. Computer-readable media can be any available media that can be accessed by computing device 100 and includes both volatile and nonvolatile media, removable and non-removable media. By way of example, and not limitation, computer-readable media may comprise computer storage media and communication media. Computer storage media includes both volatile and nonvolatile, removable and non-removable media implemented in any method or technology for storage of information such as computer-readable instructions, data structures, program modules or other data. Computer storage media includes RAM, ROM, EEPROM, flash memory or other memory technology, CD-ROM, digital versatile disks (DVD) or other optical disk storage, magnetic cassettes, magnetic tape, magnetic disk storage or other magnetic storage devices. Computer storage media of the computing device 100 may be in the form of a dedicated solid state memory or flash memory, such as a subscriber information module (SIM). Computer storage media does not comprise a propagated data signal.

Communication media typically embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer-readable media.

Memory 104 includes computer-storage media in the form of volatile and/or nonvolatile memory. Memory 104 may be removable, nonremovable, or a combination thereof. Exemplary memory includes solid-state memory, hard drives, optical-disc drives, etc. Computing device 100 includes one or more processors 106 that read data from various entities such as the bus 102, the memory 104 or the one or more I/O components 112. The one or more presentation components 108 presents data indications to a person or other device. Exemplary one or more presentation components 108 include a display device, speaker, printing component, vibrating component, etc. The one or more I/O ports 110 allow computing device 100 to be logically coupled to other devices including the one or more I/O components 112, some of which may be built in computing device 100. Illustrative I/O components 112 include a microphone, joystick, game pad, satellite dish, scanner, printer, wireless device, etc.

The radio 120 represents one or more radios that facilitate communication with one or more wireless networks using one or more wireless links. While a single radio 120 is shown in FIG. 1, it is expressly contemplated that there may be more than one radio 120 coupled to the bus 102. In aspects, the radio 120 utilizes a transmitted to communicate with a wireless telecommunications network. It is expressly contemplated that a computing device 100 with more than one radio 120 could facilitate communication with the wireless network via both the first transmitter and additional transmitters (e.g. a second transmitter). Illustrative wireless telecommunications technologies include CDMA, GPRS, TDMA, GSM, and the like. The radio 120 may carry wireless communication functions or operations using any number of desirable wireless communication protocols, including 802.11 (Wi-Fi), WiMAX, LTE, 3G, 4G, LTE, 5G, NR, VoLTE, or other VoIP communications. As can be appreciated, in various embodiments, the radio 120 can be configured to support multiple technologies and/or multiple radios can be utilized to support multiple technologies. A wireless telecommunications network might include an array of devices, which are not shown as to obscure more relevant aspects of the invention. Components such as a base station or communications tower (as well as other components) can provide wireless connectivity in some embodiments.

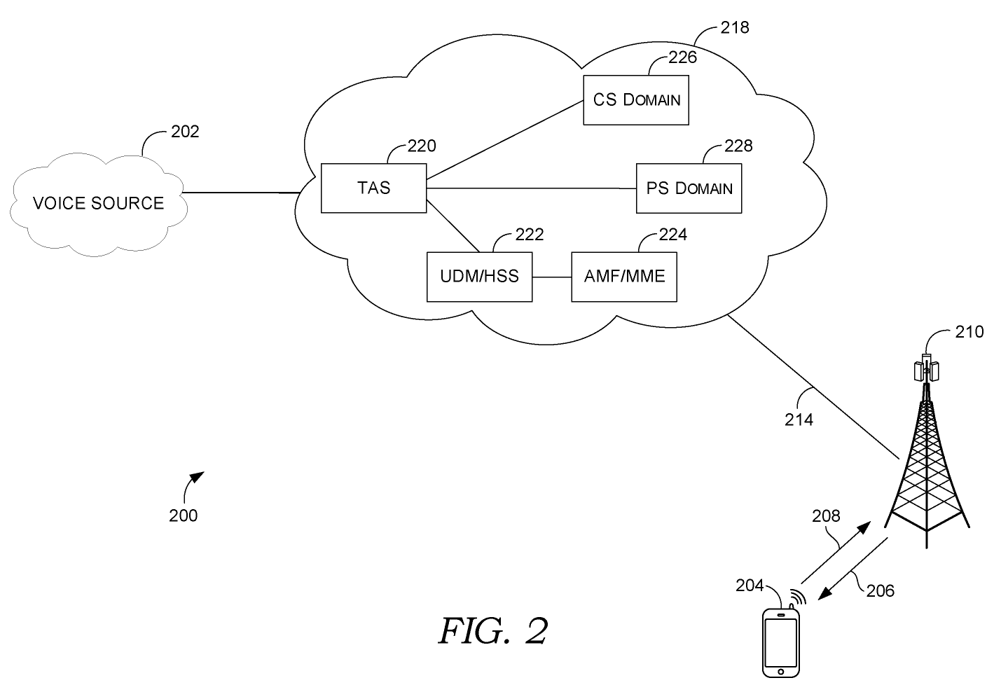

Referring now to FIG. 2, an exemplary network environment is illustrated in which implementations of the present disclosure may be employed. Such a network environment is illustrated and designated generally as network environment 200. Network environment 200 is but one example of a suitable network environment and is not intended to suggest any limitation as to the scope of use or functionality of the invention. Neither should the network environment be interpreted as having any dependency or requirement relating to any one or combination of components illustrated.

Network environment 200 represents a high level and simplified view of relevant portions of a modern wireless telecommunication network. At a high level, the network environment 200 may generally be said to comprise, one or more UEs, such as a voice source 202 and a mobile-terminating (MT) UE 204, one or more radio access nodes, such as a base station 210, and a core network 218, though in some implementations, it may not be necessary for certain features to be present. In other examples, the base station 210 may be a non-terrestrial network node (e.g., satellite). The network environment may include a number of routers, switches, and the like. The network environment 200 is generally configured for wirelessly connecting one or more devices (e.g., the MT-UE 204) to data or services that may be accessible on one or more application servers or other functions, nodes, or servers not pictured in FIG. 2 so as to not obscure the focus on the present disclosure.

The network environment 200 comprises a voice source 202. The voice source 202 may take the form of various UEs, such as a mobile-originating UE (MO-UE) (e.g., a cellphone, tablet, wearable device), and may have any one or more components and/or features of the computing device 100 of FIG. 1. In aspects, the voice source 202 is a landline telephone, a voice over IP (VoIP) phone, a satellite phone, and the like. The voice source 202 may be the originating UE associated with a call (e.g., a voice call, a video call).

The network environment 200 comprises the MT-UE 204. The MT-UE 204 is illustrated generally, and may take any number of forms, including a tablet, phone, or wearable device, or any other device discussed with respect to FIG. 1 and may have any one or more components or features of the computing device 100 of FIG. 1. In some aspects, the MT-UE 204 is a device that is capable of placing and receiving voice calls and/or video calls. In aspects, the MT-UE 204 is a receiving UE associated with the call from the voice source 202.

The network environment 200 comprises one or more radio access nodes of a radio access network (RAN), as illustrated as the base station 210, to which the MT-UE 204 may potentially connect to (also referred to as ‘camping on,’ ‘attaching,’ in the industry). Though network environment 200 is illustrated with the base station 210, one skilled in the art will appreciate that more or fewer base stations may be present in any particular network environment. Further, though the one or more radio access nodes are illustrated as the base station 210, the one or more radio access nodes may take the form of one or more non-terrestrial nodes (e.g., satellites). The base station 210 is configured to wirelessly communicate with UEs, such as the MT-UE 204. In aspects, the base station 210 may communicate with the one or more UEs (e.g., the MT-UE 204) using any wireless telecommunication protocol desired by a network operator, including but not limited to 3G, 4G, 5G, 6G, 802.11x and the like.

The base station 210 is configured to communicate with one or more UEs (e.g., the MT-UE 204). The base station 210 may communicate signals to one or more UEs via one or more downlinks 206 and receive signals from one or more UEs via one or more uplinks 208. In response to receiving certain requests from the MT-UE 204, the base station 210 may communicate with the core network 218 via a first backhaul 214. For example, in order for the MT-UE 204 to connect to a desired network service (e.g., PSTN call, voice over LTE (VoLTE) call, voice over new radio (VoNR), data, or the like), the MT-UE 204 may communicate an attach request to the base station 210, which may, in response, communicate a registration request to the core network 218 via the first backhaul 214.

The core network 218 may be configured according to one or more architectures and protocols. In some aspects, the core network 218 is a standalone (SA) 5G core network, and in other aspects, the core network 218 is configured according to other architectures (e.g., 4G, LTE, dual connectivity, non-standalone (NSA), multi-RAT integration). The present disclosure may be incorporated into various network architectures (e.g., SA, NSA, LTE, dual connectivity, 4G), which requires adapting various aspects described herein to one or more protocols and/or messaging formats associated with each architecture. Further, to implement the present disclosure on various architectures may require operating within more than one network slice, using different interfaces, and with additional security measures in place, each of which may differ depending on the architecture(s) employed in a particular network environment.

The core network 218 is comprised of one or more network functions (NFs). As used herein, the term “network function” is used to describe a computer processing module and/or one or more computer executable services being executed on one or more computing processing modules. The core network 218 may comprise NFs that include any one or more of a telephone application server (TAS) 220, a unified data management function (UDM) and/or a home subscriber server (HSS) 222, and an access and mobility management function (AMF) and/or a mobility management entity (MME) 224. In other architectures or protocols, the NFs may be given other names, however, the NFs herein refer to functions, not specifically identified components. Though the TAS 220, UDM/HSS 222, and the AMF/MME 224 are illustrated in the core network 218, the core network 218 may have more or fewer NFs than shown. Further, though the TAS 220, UDM/HSS 222, and the AMF/MME 224 are illustrated as disposed within the core network 218 it is expressly contemplated that the location in the network environment 200 is non-limiting. For example, the NFs described above may be disposed between the base station 210 and the core network 218 (i.e., the network edge) or may be isolated as stand-alone components, or a combination of these.

The core network 218 is a service-based architecture and contains NFs defined by their function. The TAS 220, for example, is generally responsible for delivering telephone services and handling call control functions like call forwarding and voicemail. In some aspects, the TAS 220 may be a multimedia telephony function (MMTel). In aspects, the TAS 220 is a mobile terminating TAS 220 associated with the MT-UE 204. The TAS 220 may be configured according to 5G protocols. The UDM/HSS 222, for example, is generally responsible for managing subscriber data and providing information relating to user profiles, policies, and subscription data. In some aspects, the UDM/HSS 222 may be solely the UDM (e.g., standalone 5G), solely the HSS (e.g., 4G), and/or the UDM is in communication with the HSS (e.g., NSA, dual connectivity, multi-RAT integration). The AMF/MME 224, for example, is generally responsible for managing registration, authentication, and mobility management of UEs. In some aspects, the AMF/MME 224 may be solely the AMF (e.g., standalone 5G), solely the MME (e.g., 4G), and/or the AMF is in communication with the MME (e.g., NSA, dual connectivity, multi-RAT integration). Each of the preceding NFs may communicate with each other via interfaces existing between them and using messages associated with one or more protocols or principles (e.g., NGAP, HTTP/2, GTP). Any particular network architecture may include any one or more of the NFs described herein, and it will be understood that various network architectures relevant to the present disclosure may take forms different from that shown in FIG. 2.

The TAS 220 may be configured to route incoming calls to a circuit-switched (CS) domain 228 or a packet-switched (PS) domain 228. The CS domain 226 is generally associated with older architectures (e.g., 2G, 3G), reduced efficiency, utilizing fixed bandwidths, stable QoS, and the like. Such dated architecture is being decommissioned at increasing rates as newer technology takes hold. The CS domain 226 may comprise a circuit switch, such as a media gateway control function (MGCF). The PS domain 228 is generally associated with newer technologies (e.g., 4G, 5G), increased efficiency, dynamic bandwidth, and QoS variability. The PS domain 228 may comprise a serving call session control function (S-CSCF) and a proxy call session control function (P-CSCF). In aspects, certain scenarios or circumstances may warrant routing the call to the CS domain 226 over the PS domain 228, and other scenarios may warrant routing the call to the PS domain 228 over the CS domain 226.

Conventionally, an invite message associated with a voice source (e.g., a call from a mobile-originating UE, a call from a landline using a public switched telephone network (PTSN)) is received by the TAS 220, which may request information from the UDM/HSS 222 relating to the MT-UE 204 to determine whether to route the invite message to the CS domain 226 or the PS domain 228. The TAS 220 may make the decision based on the MT-UE’s 204 preference for the CS domain 226 and/or the PS domain 228. However, the call routing decision determined by the TAS 220 based off of the MT-UE’s 204 preference may be the wrong choice in light of additional context the TAS 220 is unaware of. For example, if the call is destined to an MT-UE (e.g., the MT-UE 204) connected to a non-terrestrial node (e.g., a satellite connection), the PS domain 228 may use too much bandwidth to provide the level of quality that could be achieved via the CS domain 226. In another example, if the call is received from a voice source (e.g., the voice source 202) associated with a particular mobile network operator (MNO) in a different country that is unfavorable to the routing MNO (e.g., regulatory, cost, QoS concerns), the TAS 220 may decide to handle the call in another way (e.g., reject the call entirely, redirect to a voicemail server).

Relevant to the present disclosure, the TAS 220 may request location information from the UDM/HSS 222 to tailor the call routing decision made by the TAS 220. The TAS 220 may request the location information from the UDM/HSS 222 by communicating a request specifying the particular location information (e.g., parameters) the TAS 220 requests. In aspects, the communication may be communicated using HTTP/2 protocol. In aspects, the request is communicated on a N71 service-based interface (SBI). The TAS 220 may request other information beyond the location information. In some aspects, the TAS 220 requests the other information in the request, and in other aspects, the TAS 220 requests the other information via distinct messages.

The UDM/HSS 222 may request the location information from the AMF/MME 224. The request may specify at least some of the parameters of the location information requested by the TAS 220. In some aspects, the request may be communicated using HTTP/2 protocol, and in other aspects, the request may be communicated using another protocol (e.g., diameter). The request may be communicated on one or more interfaces existing between the UDM/HSS 222 and the AMF/MME 224. In aspects, the request is communicated on a N8 SBI (e.g., when the MT-UE 204 is connected to a gNB), and in other aspects, the request is communicated via an S6a interface (e.g., 4G, NSA, dual connectivity, multi-RAT integration).

The AMF/MME 224 may obtain the location information by accessing stored information on the AMF/MME 224 and/or retrieving the location information in real-time from the radio access node the MT-UE 204 is connected to (e.g., the base station 210). In some aspects, the AMF/MME 224 may house stored location information in one or more storage systems (e.g., databases). Additionally, or alternatively, the AMF/MME 224 may request location information from the radio access node the MT-UE 204 is connected to. In such aspects, the request for location information may be communicated using NGAP or other protocols (e.g., HTTP/2, diameter). The radio access node (e.g., the base station 210) may communicate the location information to the AMF/MME 224 via a backhaul (e.g., the backhaul 214). The AMF/MME 224 may then communicate the location information to the UDM/HSS 222. The UDM/HSS 222 communicates the location information to the TAS 220. In some aspects, the communication is communicated using HTTP/2 protocol and using the N71 SBI. In other aspects, the communication is communicated using other protocols and using different interfaces.

The location information may include one or more of a PLMN ID, a cell ID, a RAT type, an IP connectivity access network (CAN) type, and the like. A PLMN ID includes a mobile country code (MCC) that identifies the country in which the MNO operates, as well as a mobile network code (MNC) that identifies the specific MNO within the country specified by the MCC. Together, the PLMN uniquely identifies a particular MNO. The cell ID may identify a specific cell or sector within a MNO’s coverage area, information about the geographical location of the cell, and/or which base station is serving the MT-UE 204. The RAT type indicates to the nature of the connection between the one or more radio access nodes (e.g., the base station 210) and the MT-UE 204. For example, the RAT type may indicate that the MT-UE 204 is connected to a node of a non-terrestrial network, an eNB (4G), a gNB (5G), and the like. The location information may also include an IP CAN type, which indicates the particular access technology to the core network 218. The location information may also include a tracking area identifier, new radio cell global identifier (NRCGI), enhanced cell ID, global navigation satellite system (GPS) coordinates, Wi-Fi location, Bluetooth location, round trip time, time difference of arrival, angle of arrival, and the like.

In some aspects, the UDM/HSS 222 also communicates other information to the TAS 220. For example, the UDM/HSS 222 may communicate subscriber profile data (e.g., services a subscriber associated with the MT-UE 204 is entitled to, authentication information), subscription information (e.g., QoS parameters assigned to the MT-UE 204, data usage policies), access data (e.g., restrictions on access to particular services), MNO policies (e.g., MNO preferences of the MNO serving the MT-UE 204), and the like. For example, the UDM/HSS 222 may store MNO policies associated with the MNO of the MT-UE 204 such that the TAS 220 considers the location information and the remaining other information in light of these MNO policies. For example, if the invite message originates from an unfavorable MNO based on these MNO policies, the TAS may elect to reject the call.

The call routing decision may be made based on the TAS’s 220 consideration of the location information, the other information, and/or invite information. Invite information is information existing within the invite message being routed. The invite information may include session description protocol (SDP) media descriptions and/or payloads within the invite message, such as whether the invite message includes a request to initiate a video voice call (e.g., video media description in SDP payload). The invite information may inform the TAS 220 of how much bandwidth or network resources the call will require, which may influence the call routing decision. Once the TAS 220 has relevant information (e.g., the location information, the other information, the invite information), the TAS 220 makes a call routing decision regarding the invite message from the voice source 202.

In some aspects, the call routing decision may include routing the invite message to the CS domain 226 or the PS domain 228. For example, the TAS 220 considers the location information, at least some of the other information, and/or the invite information to determine whether to route the invite message to the CS domain 226 or the PS domain 228. For example, the MT-UE 204 may fail to register with an IMS network (e.g., roaming scenarios), which would typically result in routing via the CS domain 226, however after considering the location information, the TAS 220 may determine to route the invite message to the PS domain 228. In other aspects, the call routing decision includes the possibility of routing the invite message to the CS domain 226, the PS domain 228, redirecting the invite message, and/or rejecting the invite message. For example, the TAS 220 determines the MT-UE 204 is connected to a non-terrestrial network, which is often considered unsuitable for voice calling, and may decide to redirect the invite message to a voicemail server associated with the MT-UE 204. In another example, the TAS 220 determines the MT-UE 204 originates from an undesirable PLMN and may decide to reject the call by rejecting the invite message. In this example, the TAS 220 may respond to the invite message by notifying the voice source 202 that the call is forbidden (e.g., 403 forbidden), temporarily unavailable (e.g., 480 temporarily unavailable), not acceptable (e.g., 488 not acceptable here), and the like.

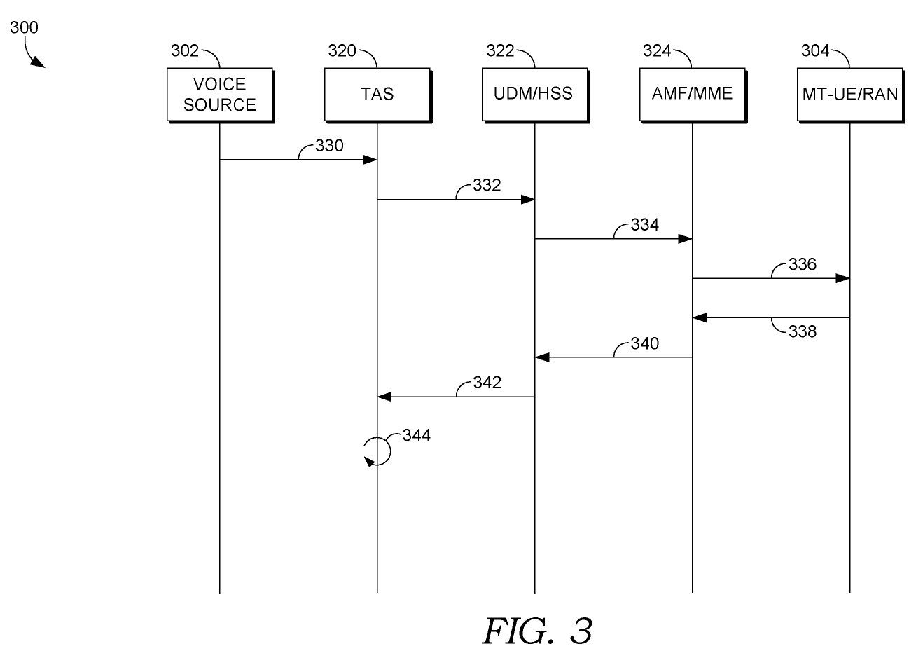

Turning now to FIG. 3, a call flow diagram is illustrated in accordance with one or more aspects of the present disclosure. A call flow 300 may be said to exist between one or more NFs discussed in greater detail herein and is not meant to exhaustively show every interaction that would be necessary to practice the invention, so as not to obscure the present disclosure, but is instead meant to illustrate one or more potential interactions between NFs. The call flow 300 may generally include a voice source 302 (e.g., the voice source 202 of FIG. 2), a TAS 320 (e.g., the TAS 220 of FIG. 2), a UDM/HSS 322 (e.g., the UDM/HSS 222 of FIG. 2), an AMF/MME 324 (e.g., the AMF/MME 224 of FIG. 2), and an MT-UE 304 (e.g., the MT-UE 204 of FIG. 2). The MT-UE 304 may be connected to a radio access node of a radio access network (RAN), each of which may be associated with one or more RAT types (e.g., terrestrial 4G, non-terrestrial SA 5G). In aspects, the MT-UE 304 is connected to a network having one or more architectures (e.g., 4G, LTE, 5G SA, NSA, dual connectivity, multi-RAT integration). Each of the preceding NFs may take different forms, including consolidated or distributed forms that perform the same general operations. In other architectures or protocols, the NFs may be given other names, however, the NFs herein refer to functions, not specifically identified components.

At a first step 330, the voice source 302 communicates an invite message to the TAS 320. In some aspects, the voice source 202 is an MO-UE, and in other aspects, the voice source 202 is a landline telephone or other calling device. In aspects, the invite message may be indirectly communicated to the TAS 320 via one or more intermediate NFs. For example, the invite message may be routed through an originating TAS before reaching the TAS 320, which may be considered a terminating TAS. In aspects, the invite message is a session initiation protocol (SIP) invite message, and the invite message may be communicated via SIP to the TAS 320. In some aspects, the invite message is associated with a regular voice session, and in other aspects, the invite message is associated with a video call session.

At a second step 332, the TAS 320 requests information from the UDM/HSS 322. In some aspects, the TAS 320 requests location information, as described with respect to FIG. 2. The TAS 320 may request other relevant information, as described with respect to FIG. 2. For example, in addition to the location information, the TAS 320 may request other information (e.g., MNO policies) in addition to the location information, as described with respect to FIG. 2. The request may have one or more aspects described with respect to FIG. 2. In some aspects, the request is a “GET” message requesting “Nhss_imsSubscriberDataManagement/access-data/ps-domain/tads-info” and “Nhss_imsSubscriberDataManagement/access-data/ps-domain/location-data/amfLocation.” In other aspects, the request may take other forms and/or be formatted according to other protocols, as described with respect to FIG. 2.

At a third step 334, the UDM/HSS 322 requests location information from the AMF/MME 324. The request may include a UE and/or subscriber identifier associated with the MT-UE 304 to assist the AMF/MME 324 in processing the request. In aspects, the request is a “POST” request including “Namf_Location/provide-loc-info.” In other aspects, the request may take other forms and/or be formatted according to other protocols, as described with respect to FIG. 2.

In a first aspect of FIG. 3, at a fourth step 336, the AMF/MME 324 requests at least some of the location information from the radio access node associated with the MT-UE 304. The AMF/MME 324 may request real-time location information and/or the AMF/MME 324 may request stored location information stored on the radio access node. In some aspects, the AMF/MME 324 may request at least some of the location information via an NGAP location request. In other aspects, the location request takes different forms and/or is configured according to other protocols, as described with respect to FIG. 2. In some aspects, the AMF/MME 324 may obtain at least some of the location information from the radio access node and other portions of the location information from a storage system of the AMF/MME 324 and/or a storage system in communication with the AMF/MME 324. In such aspects, at a fifth step 338, the radio access node associated with the MT-UE 304 communicates the at least some of the location information to the AMF/MME 324. In some aspects, the location response is an NGAP location response, and in other aspects, the response may take other forms and/or be configured according to other protocols, as described with respect to FIG. 2.

In a second aspect of FIG. 3, at the fourth step 336, the AMF/MME 324 retrieves the location information from a storage system of the AMF/MME 324 and/or a storage system in communication with the AMF/MME 324. In such aspects, the AMF/MME 324 does not request the location information from a radio access node of the MT-UE 304, and the AMF/MME 324 does not receive the location information from the radio access node of the MT-UE 304. Instead, the AMF/MME 324 accesses stored location information in the storage system. In some aspects, the AMF/MME 324 may query the storage system for the location information.

At a sixth step 340, the AMF/MME 324 communicates the location information to the UDM/HSS 322. In some aspects, the location response from the AMF/MME 324 is a “200 OK” message including “ProvideLocInfo,” and in other aspects, the response takes other forms and/or is configured according to other protocols, as described with respect to FIG. 2. At a seventh step 342, the UDM/HSS 322 communicates the information to the TAS 320. In aspects, the UDM/HSS 322 may communicate the location information received from the AMF/MME 324 and/or the other information requested by the TAS 320, as described with respect to FIG. 2. In such aspects, the UDM/HSS 322 may obtain the other information from storage systems of the UDM/HSS 322 and/or storage systems in communication with the UDM/HSS 322. In aspects, the response to the TAS 320 is a “200 OK” message including “PsLocation/amfLocation.” In other aspects, the response takes other forms and/or is configured according to other protocols, as described with respect to FIG. 2.

At an eighth step 344, the TAS 320 makes the call routing decision based on at least some of the information (e.g., location information, other information) received from the UDM/HSS 322 and/or the invite information, as described with respect to FIG. 2. The call routing decision may include routing the invite message to a CS domain (e.g., the CS domain 226 of FIG. 2), routing the invite message to a PS domain (e.g., the PS domain 228 of FIG. 2), redirecting the invite message (e.g., to a voicemail server), or rejecting the call (e.g., sending a not available response back to the voice source 302).

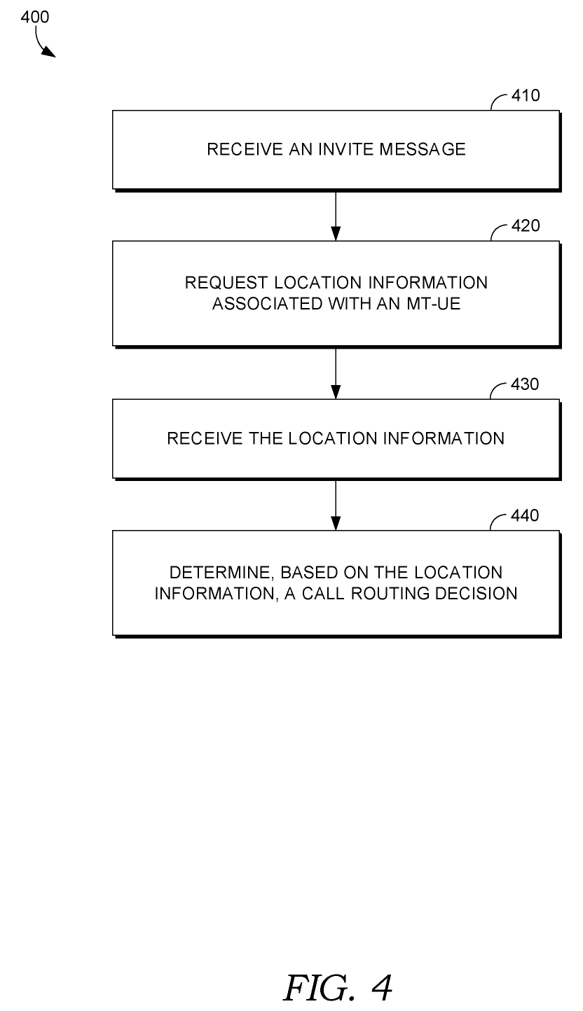

Turning now to FIG. 4, a flow chart is provided that illustrates one or more aspects of the present disclosure relating to a method 400 for making a call routing decision associated a call from a voice source (e.g., the voice source 202 of FIG. 2, the voice source 302 of FIG. 3). The method 400 may include one or more aspects described with respect to FIGS. 2-3.

At a first step 410, a TAS (e.g., the TAS 220 of FIG. 2, the TAS 320 of FIG. 3) receives an invite message associated with the call. In aspects, the TAS is an MMTel. In aspects, the TAS is a terminating TAS. At a second step 420, the TAS requests location information associated with an MT-UE from a subscriber NF. In some aspects, the TAS may request other information (e.g., subscriber data, subscription information), as described with respect to FIG. 2. In aspects, the subscriber NF is a UDM and/or an HSS (e.g., the UDM/HSS 222 of FIG. 2, the UDM/HSS 322 of FIG. 3). In aspects, the subscriber NF may provide other information, as described with respect to FIG. 2. The location information may include one or more aspects described with respect to FIG. 2.

At a third step 430, the TAS receives the location information from the subscriber NF. At a fourth step 440, the TAS determines, based on the location information, the call routing decision. In aspects, the TAS may consider the other information and/or the invite information when determining the call routing decision. The call routing decision may include one of routing the invite message to a first domain, routing the invite message to a second domain, redirecting the invite message, or rejecting the invite message, as described with respect to FIG. 2. In such aspects, the first domain may be a CS domain (e.g., the CS domain 226 of FIG. 2) and the second domain may be a PS domain (e.g., the PS domain 228 of FIG. 2). The TAS may, based on the call routing decision, route the invite message according to the call routing decision.

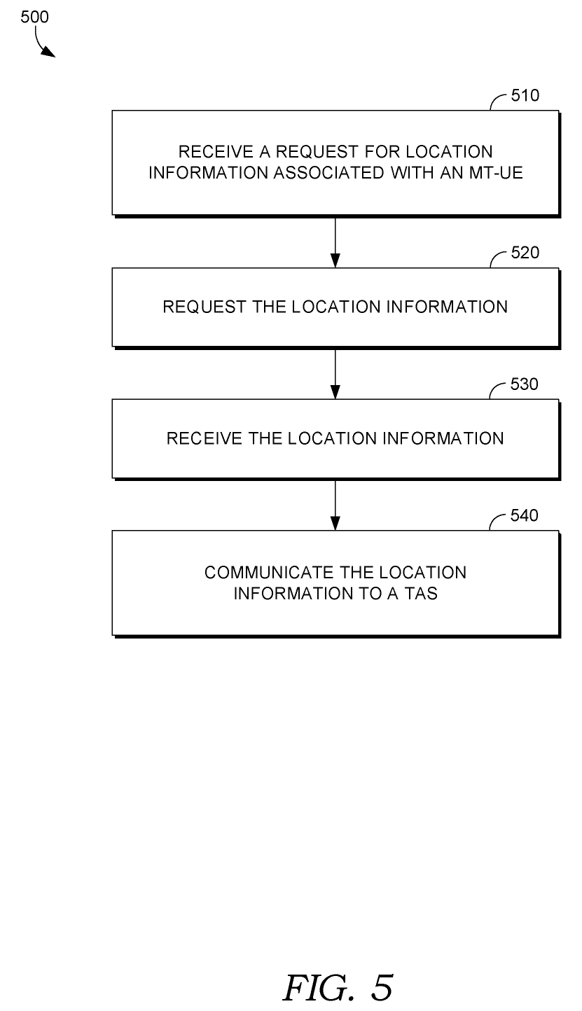

Turning now to FIG. 5, a flow chart is provided that illustrates one or more aspects of the present disclosure relating to a method 500 for facilitating a call routing decision associated with a call from a voice source (e.g., the voice source 202 of FIG. 2, the voice source 302 of FIG. 3). The method 500 may incorporate one or more aspects described with respect to FIGS. 2-4.

At a first step 510, a subscriber NF receives a request for location information from a TAS (e.g., the TAS 220 of FIG. 2, the TAS 320 of FIG. 3). In aspects, the subscriber NF is a UDM and/or an HSS (e.g., the UDM/HSS 222 of FIG. 2, the UDM/HSS 322 of FIG. 3). At a second step 520, the subscriber NF requests the location information. In aspects, the subscriber NF requests the location information from a mobility NF, such as an AMF and/or an MME (e.g., the AMF/MME 224 of FIG. 2, the AMF/MME 324 of FIG. 3). The mobility NF may obtain the location in real-time, from a storage system, or a combination of these, as described with respect to FIGS. 2-3. At a third step 530, the subscriber NF receives the location information from the mobility NF. At a fourth step 540, the subscriber NF communicates the location information to the TAS. In aspects, the subscriber NF may communicate other information to the TAS, as described with respect to FIG. 2.

Many different arrangements of the various components depicted, as well as components not shown, are possible without departing from the scope of the claims below. Embodiments in this disclosure are described with the intent to be illustrative rather than restrictive. Alternative embodiments will become apparent to readers of this disclosure after and because of reading it. Alternative means of implementing the aforementioned can be completed without departing from the scope of the claims below. Certain features and subcombinations are of utility and may be employed without reference to other features and subcombinations and are contemplated within the scope of the claims.

In the preceding detailed description, reference is made to the accompanying drawings which form a part hereof wherein like numerals designate like parts throughout, and in which is shown, by way of illustration, embodiments that may be practiced. It is to be understood that other embodiments may be utilized and structural or logical changes may be made without departing from the scope of the present disclosure. Therefore, the preceding detailed description is not to be taken in the limiting sense, and the scope of embodiments is defined by the appended claims and their equivalents.

What is claimed is:

1. A method for making a call routing decision associated with a call, the method comprising:
receiving, at a telephone application server (TAS), an invite message associated with the call;
requesting location information associated with a mobile-terminating UE (MT-UE) from a subscriber network function (NF);
receiving the location information from the subscriber NF;
determining, based on the location information, the call routing decision, wherein the call routing decision comprises one of: routing the invite message to a first domain, routing the invite message to a second domain, redirecting the invite message, or rejecting the invite message; and
routing, based on the call routing decision, the invite message.

2. The method of claim 1, wherein the location information comprises at least one of: a public land mobile network identifier (PLMN ID), a cell ID, or a radio access technology (RAT) type.

3. The method of claim 1, wherein the first domain is a circuit-switched (CS) domain, and the second domain is a packet-switched (PS) domain.

4. The method of claim 3, wherein the location information comprises a PLMN ID, a cell ID, and a RAT type.

5. The method of claim 4, wherein the RAT type is a non-terrestrial radio access network (RAN), and wherein the invite message is redirected to a voicemail server.

6. The method of claim 3, wherein the MT-UE fails to register with an IP multimedia system (IMS) network, and wherein, based on the location information, the invite message is routed to the PS domain.

7. The method of claim 6, wherein the MT-UE is a roaming UE.

8. The method of claim 1, wherein the call routing decision is further based on whether the invite message includes video media in a session description protocol (SDP) payload.

9. A method for facilitating a call routing decision associated with a call, the method comprising:
receiving, at a subscriber network function (NF), a request for location information and subscriber information associated with a mobile-terminating UE (MT-UE) from a telephone application server (TAS);
requesting the location information from a mobility NF;
receiving the location information from the mobility NF; and
communicating the location information and the subscriber information to the telephone application server, wherein the TAS makes the call routing decision based on the location information and the subscriber information.

10. The method of claim 9, wherein the call routing decision comprises one of: routing an invite message associated with the call to a CS domain, routing the invite message to a PS domain, redirecting the invite message, or rejecting the invite message.

11. The method of claim 9, wherein the location information comprises at least one of: a PLMN ID, a cell ID, or a RAT type, and wherein the subscriber information comprises at least one of: subscribed services, quality of service (QoS) parameters, or mobile network operator (MNO) policies.

12. The method of claim 11, wherein the call routing decision is further based on whether an invite message associated with the call includes video media in a session description protocol (SDP) payload.

13. The method of claim 9, wherein the location information comprises a RAT type, wherein the RAT type is a non-terrestrial network, and wherein the call routing decision comprises rejecting an invite message associated with the call.

14. The method of claim 9, wherein the mobility NF comprises one or more of an access and mobility management function (AMF) and a mobility management entity (MME), and wherein the mobility NF retrieves the location information from the MT-UE in real time.

15. A system for making a call routing decision associated with a call, the system comprising:
one or more computer-processing components configured to execute operations comprising:
receiving, at a telephone application server (TAS), an invite message associated with the call;
requesting location information associated with a mobile-terminating UE (MT-UE) from a subscriber network function (NF);
receiving the location information from the subscriber NF;
determining, based on the location information, the call routing decision, wherein the call routing decision comprises one of: routing the invite message to a first domain or routing the invite message to a second domain; and
routing, based on the call routing decision, the invite message.

16. The system of claim 15, wherein the location information comprises at least one of: a PLMN ID, a cell ID, or a RAT type.

17. The system of claim 15, wherein the first domain is a CS domain and the second domain is a PS domain.

18. The system of claim 17, wherein the MT-UE is a roaming UE, wherein the roaming UE is not registered on an IMS network, and wherein the call routing decision comprises routing the invite message to the PS domain.

19. The system of claim 15, wherein the TAS requests other information, and wherein the other information includes at least one of: subscribed services, quality of service (QoS) parameters, or mobile network operator (MNO) policies, and wherein the call routing decision is further determined based on the other information.

20. The system of claim 15, wherein the TAS requests the location information from the subscriber NF using a HTTP-based protocol.
